(19) United States
(12) Patent Application Publication
(10) Pub. No.: US 2022/0112126 A1
(43) Pub. Date: Apr. 14, 2022

(54) TEMPERED GLASS PLATE AND METHOD FOR PRODUCING SAME

(71) Applicant: AGC Inc., Tokyo (JP)

(72) Inventors: Isao SAITO, Tokyo (JP); Yasumasa KATO, Tokyo (JP); Takuma FUJIWARA, Tokyo (JP)

(73) Assignee: AGC Inc., Tokyo (JP)

(21) Appl. No.: 17/645,791

(22) Filed: Dec. 23, 2021

Related U.S. Application Data
(63) Continuation of application No. PCT/JP2020/024383, filed on Jun. 22, 2020.

(30) Foreign Application Priority Data
Jun. 27, 2019 (JP) 2019-120489

(51) Int. Cl. C03C 23/00; C03C 21/00; C03B 33/09; C03C 3/087

(52) U.S. Cl. CPC C03C 23/0025; C03C 21/002; C03B 2201/54; C03C 3/087; C03B 33/091

(57) ABSTRACT

The present invention relates to a strengthened glass sheet having a first main surface, a second main surface which faces the first main surface, and an end surface, in which at least one of the first main surface and the second main surface has a surface compressive stress formed by a chemical strengthening treatment, the strengthened glass sheet includes a strengthened portion in which a planar compressive stress is formed along the end surface in a direction parallel with the end surface, the planar compressive stress of the strengthened portion has a maximum value of 1-120 MPa, and the strengthened portion has a width, as measured from the end surface in a direction normal to the end surface, of 0.5 times or more a thickness of the strengthened glass sheet.

### TECHNICAL FIELD

The present invention relates to a strengthened glass sheet and a method of producing the strengthened glass sheet.

### BACKGROUND ART

Known is a strengthened glass sheet obtained by inducing compressive stress in the main surfaces of a glass sheet and tensile stress in an inner portion thereof in order to improve the strength of the glass sheet. Among strengthened glasses, there are a physically strengthened glass obtained by heating a glass sheet and then rapidly cooling it to thereby cause a temperature difference between each main surface and an inner portion and a chemically strengthened glass obtained by immersing a glass sheet in a molten salt to cause ion exchange between ions on the main surface side which have a small ionic radius and ions on the molten-salt side which have a large ionic radius.

Chemically strengthened glass sheets are resistant to sudden impacts since the compressive stress layers formed in the main surfaces are thicker than those of the physically strengthened glass sheets. Because of this, chemically strengthened glass sheets have been used from old times as the cover glasses of wristwatches and in recent years as the cover glasses of smartphones, etc. Patent Document 1 proposes a chemically strengthened glass sheet for use as windows of buildings, external walls, cover glasses of solar cells, or windows of vehicles.

### CITATION LIST

### Patent Literature

Patent Document 1: International Publication WO 2014/168246

### SUMMARY OF INVENTION

### Technical Problem

Chemically strengthened glass sheets are resistant to impacts on the main surfaces but have poor resistance to impacts on the end surfaces, and are prone to break upon reception of a defect, e.g., a crack, in end surfaces.

The present invention provides a strengthened glass sheet which has both high main surface strength and high end surface strength and is less apt to break and a method of producing the strengthened glass sheet.

### Solution to the Problem

The strengthened glass sheet of the present invention is a strengthened glass sheet having a first main surface, a second main surface which faces the first main surface, and an end surface,

in which at least one of the first main surface and the second main surface has a surface compressive stress formed by a chemical strengthening treatment,

the strengthened glass sheet includes a strengthened portion in which a planar compressive stress is formed along the end surface in a direction parallel with the end surface,

the planar compressive stress of the strengthened portion has a maximum value of 1-120 MPa, and

the strengthened portion has a width, as measured from the end surface in a direction normal to the end surface, of 0.5 times or more a thickness of the strengthened glass sheet.

The method of the present invention for producing a strengthened glass sheet, which is a method for obtaining the strengthened glass sheet, includes

a chemical strengthening treatment step of immersing at least one of main surfaces of a glass sheet in a molten salt to form a surface compressive stress in the main surface of the glass sheet; and

an end surface strengthening step of, after the chemical strengthening treatment step, forming a planar compressive stress along an end surface of the glass sheet in a direction parallel with the end surface,

in which in the end surface strengthening step, the glass sheet is heated so that a temperature T1 is not lower than a strain point of the glass sheet, where the temperature T1 is a temperature of a portion of the glass sheet lying at a distance equal to a thickness of the strengthened glass sheet from the end surface along a direction normal to the end surface; the end surface has a temperature T2 which is lower than a softening point of the glass sheet; and a relation T1>T2 is satisfied.

### Advantageous Effects of Invention

The strengthened glass sheet of the present invention is characterized by having both high main surface strength and high end surface strength and being less apt to break.

### BRIEF DESCRIPTION OF DRAWINGS

FIG. 1 is a perspective view of a strengthened glass sheet according to one embodiment of the present invention.

FIG. 2 is a plan view of the strengthened glass sheet according to one embodiment of the present invention.

FIG. 3 The part (A) of FIG. 3 is a cross-sectional view of the strengthened glass sheet according to one embodiment of the present invention; the part (B) of FIG. 3 is a plan view of the strengthened glass sheet according to one embodiment of the present invention; and the part (C) of FIG. 3 shows a relationship in the strengthened glass sheet according to one embodiment of the present invention between the distance from an end surface and planar compressive stress in a parallel direction.

FIG. 4 is a cross-sectional view of a strengthened glass sheet which is being irradiated with laser light in an end surface strengthening step.

FIG. 5 is a cross-sectional view of the strengthened glass sheet obtained in Working Example.

FIG. 6 shows Weilbull plots of Example 1 and Example 2.

### DESCRIPTION OF EMBODIMENTS

A strengthened glass sheet according to one embodiment of the present invention is explained in detail below by reference to drawings.

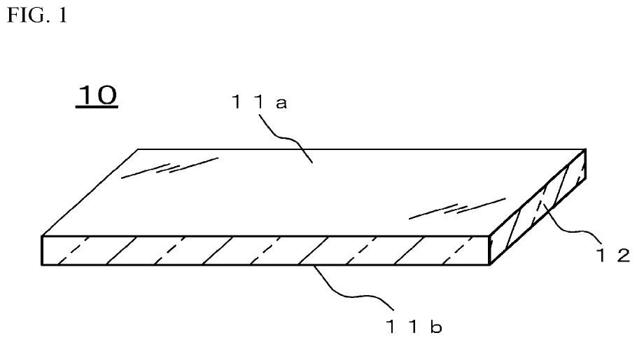

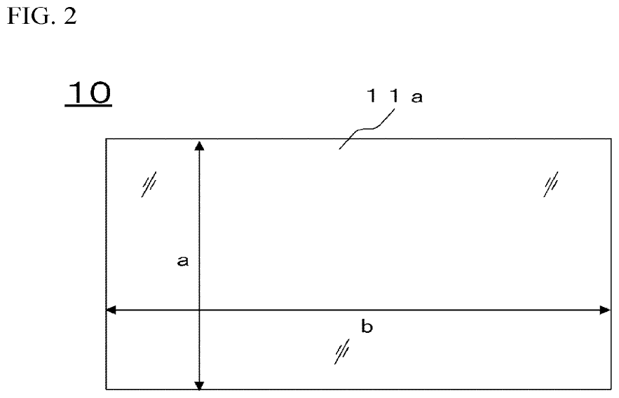

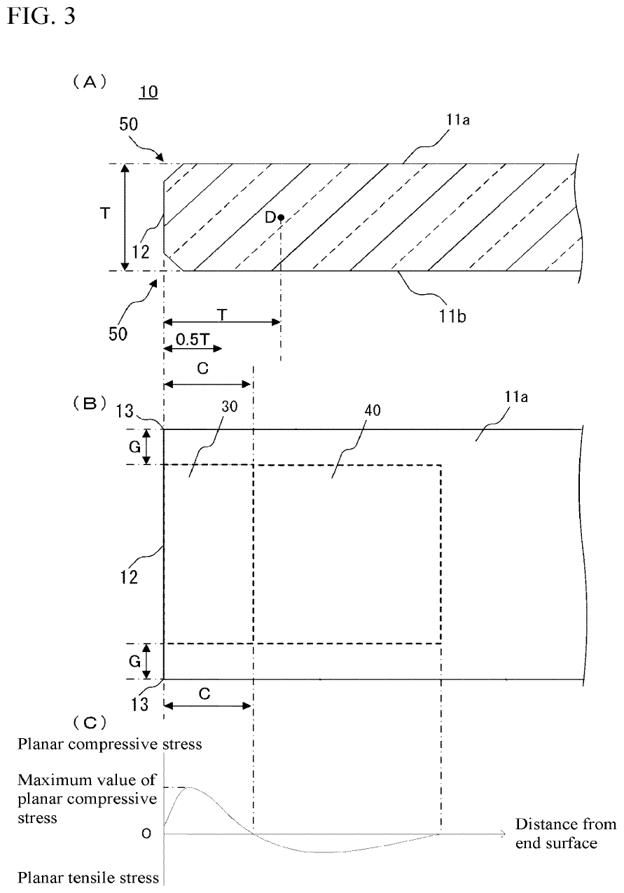

FIG. 1 is a perspective view of a strengthened glass sheet according to one embodiment of the present invention. FIG. 2 is a plan view of the strengthened glass sheet according to one embodiment of the present invention. The part (A) of FIG. 3 is a cross-sectional view of the strengthened glass sheet according to one embodiment of the present invention, and the part (B) of FIG. 3 is a plan view of the strengthened glass sheet according to one embodiment of the present invention. The part (C) of FIG. 3 is a diagram showing a relationship in the strengthened glass sheet according to one embodiment of the present invention between the distance from an end surface and planar compressive stress.

The strengthened glass sheet 10 according to one embodiment of the present invention is a strengthened glass sheet which has a first main surface 11a, a second main surface 11b, which faces the first main surface 11a, and an end surface 12, and in which at least one of the first main surface 11a and the second main surface 11b has surface compressive stress therein formed by a chemical strengthening treatment. This strengthened glass sheet 10 includes a strengthened portion 30 in which planar compressive stress is formed along the end surface 12 in a direction parallel with the end surface 12. The planar compressive stress of the strengthened portion 30 has a maximum value of 1-120 MPa. The strengthened portion 30 has a width C, as measured from the end surface 12 along a direction normal to the end surface 12, of 0.5 times or more the thickness T of the strengthened glass sheet.

The strengthened glass sheet 10 according to one embodiment of the present invention is suitable for use as, for example, windows of buildings, external walls, handrail materials, cover glasses for solar cells, or windows of vehicles. Examples of the windows of buildings include windows of dwelling houses and other buildings.

The strengthened glass sheet according to one embodiment of the present invention can be used as single-sheet glasses in various applications including windows of buildings, external walls, handrail materials, cover glasses for solar cells, or windows of vehicles. In another embodiment, the strengthened glass sheet can be used in laminated glasses obtained by laminating two or more sheets of glass with an interlayer film.

In a still another embodiment, the strengthened glass sheet can be used in a multi-layered glass including two or more sheets of glass disposed so as to leave a space therebetween. In a further embodiment, the strengthened glass sheet can be used in the state of having a coating formed on a surface thereof.

In the configuration of the laminated glass or multi-layered glass, the strengthened glass sheet of the present invention can be used as at least one of the sheets.

In the strengthened glass sheet 10 according to one embodiment of the present invention, at least one of the main surfaces 11a and 11b has surface compressive stress therein formed by a chemical strengthening treatment. It is, however, preferable that the main surfaces 11a and 11b both have been chemically strengthened to have surface compressive stress therein.

In the strengthened glass sheet 10 according to one embodiment of the present invention, at least one of the main surfaces 11a and 11b has surface compressive stress formed therein by, as will be described later, subjecting a preheated glass sheet to a chemical strengthening treatment in which the glass sheet is immersed in a molten salt, e.g., a heated potassium-nitrate molten salt, to cause ion exchange between, for example, Na in a surface layer of the glass and K in the molten salt. Because of this, the main surface 11a or 11b in which surface compressive stress has been formed has a lower Na content than an inner portion of the strengthened glass sheet 10.

In the strengthened glass sheet 10 according to one embodiment of the present invention, the surface compressive stress in at least one of the first main surface 11a and the second main surface 11b preferably has a surface compressive stress value (hereinafter referred to also as CS) of 200 MPa or more. CS values of 200 MPa or more are preferred because this strengthened glass sheet has enhanced mechanical strength. The CS thereof is more preferably 250 MPa or more, still more preferably 300 MPa or more, especially preferably 350 MPa or more, most preferably 380 MPa or more.

Meanwhile, in at least one of the first main surface 11a and the second main surface 11b, the CS of the surface compressive stress is preferably 1,200 MPa or less. In cases when the CS thereof is 1,200 MPa or less, this strengthened glass sheet is less apt to have exceedingly high internal tensile stress. In addition, the step of chemical strengthening treatment may be short-period immersion in a high-temperature molten salt, making it easy to obtain the strengthened glass sheet 10. Moreover, in cutting the strengthened glass sheet 10, it is easy to make cutting lines with a wheel cutter. The CS thereof is more preferably 800 MPa or less, still more preferably 500 MPa or less, especially preferably 480 MPa or less, most preferably 460 MPa or less. The values of the CS of surface compressive stress are ones measured at the center of gravity of the first main surface 11a or second main surface 11b.

In the strengthened glass sheet 10 according to one embodiment of the present invention, at least one of the first main surface 11a and the second main surface 11b preferably has a sheet-thickness-direction depth of surface compressive stress (hereinafter referred to also as DOL) of 5 μm or more. In cases when the DOL thereof is 5 μm or more, sufficient strength is obtained and the strengthened glass sheet 10 can withstand impacts. The DOL thereof is more preferably 10 μm or more, still more preferably 20 μm or more, especially preferably 30 μm or more, most preferably 40 μm or more.

Meanwhile, the DOL of surface compressive stress is preferably 100 μm or less. In cases when the DOL thereof is 100 μm or less, the immersion in a molten salt may be performed only for a short period, making it easy to obtain the strengthened glass sheet 10. The DOL thereof is more preferably 80 μm or less, still more preferably 60 μm or less, especially preferably 50 μm or less. The values of the DOL of surface compressive stress are ones measured at the center of gravity of the first main surface 11a or second main surface 11b.

The CS and the DOL can be measured with a surface stress meter.

In the strengthened glass sheet 10 according to one embodiment of the present invention, the end surface 12 may not have surface compressive stress formed by a chemical strengthening treatment. As will be described later, a glass sheet 10 having an end surface 12 where no surface compressive stress has been formed can be obtained by cutting a glass sheet which has undergone a chemical strengthening treatment. Strengthened glass sheet 10 produced by such method is excellent in productivity, because it is obtained by strengthening a large glass sheet and thereafter cutting the strengthened glass sheet into a use size.

The end surface 12 may have a chamfer 50 at the boundary between the end surface 12 and the first main surface 11a and at the boundary between the end surface 12 and the second main surface 11b. In cases when the end surface 12 has the chamfers 50, the strengthened glass sheet 10 is less apt to suffer corner chipping when used in any of various applications including windows of buildings, external walls, handrail materials, cover glasses for solar cells, and windows of vehicles. Examples of the kind of chamfering for the end surface 12 include C-chamfering, R-chamfering, and a combination of R-chamfering and C-chamfering. The shape of the chamfers of the end surface 12 may be linear or curved. The end surface 12 may have been chamfered and then polished. The polishing can remove processing flaws caused by the chamfering. The end surface 12 may be one formed by thermal-stress scribing with a laser or a gas burner and subsequently cutting the glass sheet, so that cutting the glass sheet does not result in the occurrence of microcracks. In cases when the end surface 12 is formed by cutting performed after polishing or thermal-stress scribing, it is possible to reduce the scattering of laser light in the end surface strengthening step which will be described later.

The strengthened glass sheet 10 according to one embodiment of the present invention includes a strengthened portion 30 in which planer compressive stress is formed along the end surface 12 in a direction parallel with the end surface 12. The width C of the strengthened portion 30, as measured from the end surface 12 along a direction normal to the end surface 12, is 0.5 times or more the thickness T of the strengthened glass sheet. Since the strengthened glass sheet 10 includes the strengthened portion 30, which has a width C of 0.5 times or more the thickness T of the strengthened glass sheet, provided to the end surface 12, the strengthened glass sheet 10 is resistant to tensile stress generating in the end surface 12 when a temperature distribution has occurred in the strengthened glass sheet 10. Hence, the end surface 12 is less apt to suffer defects, e.g., cracks, and the strengthened glass sheet 10 is less apt to break.

The width C of the strengthened portion is preferably 0.7 times or more, more preferably 1.0 time or more, still more preferably 1.5 times or more, especially preferably 2.0 times or more, the thickness T of the strengthened glass sheet 10. There is no particular upper limit on the width C of the strengthened portion. However, from the standpoint of reducing the influence of planar tensile stress occurring in a position 40 adjacent to the strengthened portion 30 on the opposite side thereof to the end surface 12 along a direction parallel with the end surface 12, the width C may be 5.0 times or less, or 4.0 times or less, or 3.0 times or less, the thickness T of the strengthened glass sheet 10.

Here, the strengthened glass sheet 10 is examined for deviatoric stress in a direction perpendicular to the first main surface 11a and second main surface 11b with a two-dimensional birefringence distribution analyzer. This deviatoric stress is planar stress; the deviatoric stress along a direction parallel with the end surface 12 is regarded as planar compressive stress when it is compressive, and is regarded as planar tensile stress when it is tensile. The term “width C of the strengthened portion” means a minimum distance, in one main surface 11a or 11b of the strengthened glass sheet 10, from the edge of the main surface 11a or 11b to a position where the measured value of planar compressive stress is 0.

The strengthened portion 30 may not be formed in a corner 13 where adjoining end surfaces 12 meet each other. The distance G between the corner 13 where adjoining end surfaces 12 meet each other to the strengthened portion 30 may be 1.0 time or more but 10 times or less the thickness T of the strengthened glass sheet 10.

In cases when the strengthened glass sheet 10 has no corner 13 because of corner rounding, the distance from the corner where virtual extensions of the adjoining end surfaces 12 meet each other to the strengthened portion 30 may be 1.0 time or more but 10 times or less the thickness T of the strengthened glass sheet 10.

In the strengthened glass sheet 10 according to one embodiment of the present invention, the planar compressive stress of the strengthened portion 30 has a maximum value of 1-120 MPa. Since the maximum value of the planar compressive stress of the strengthened portion 30 is 1 MPa or more, the end surface 12 has high mechanical strength. The maximum value of the planar compressive stress of the strengthened portion 30 is more preferably 2 MPa or more, still more preferably 3 MPa or more, especially preferably 5 MPa or more. Since the maximum value of the planar compressive stress of the strengthened portion 30 is 120 MPa or less, the planar tensile stress which has generated in the position 40 adjacent to the strengthened portion 30 on the opposite side thereof to the end surface 12 is not too strong and the strengthened glass sheet 10 is less apt to break even when the main surface 11a or 11b of the strengthened glass sheet 10 receives a flaw. The maximum value of the planar compressive stress of the strengthened portion 30 may be 100 MPa or less, or 50 MPa or less, or 30 MPa or less, or 20 MPa or less. The term “maximum value of the planar compressive stress” means a maximum value of the planar compressive stress of the strengthened portion measured in an examination of one main surface of the strengthened glass sheet 10 with a two-dimensional birefringence distribution analyzer; the maximum value is shown in the part (C) of FIG. 3.

It is preferable that the strengthened glass sheet 10 according to one embodiment of the present invention has no planar tensile stress in the strengthened portion 30. In cases when the strengthened portion 30 has no planar tensile stress therein, the strengthened glass sheet 10 is less apt to suffer thermal breakage.

The strengthened glass sheet 10 according to one embodiment of the present invention may have a protective layer formed on the end surface 12. Examples of the protective layer include an adhesive tape, an ultraviolet-cured resin, and a hot-melt resin.

In the strengthened glass sheet 10 according to one embodiment of the present invention, the first main surface 11a and the second main surface 11b each preferably have an area of 0.001 m² or more. In cases when the area thereof is 0.001 m² or more, the strengthened glass sheet 10 is suitable for use in various applications including windows of buildings, external walls, cover glasses for solar cells, and windows of vehicles. The area of the first main surface 11a and that of the second main surface 11b each may be 0.1 m² or more, or 1 m² or more, or 2 m² or more, or 3 m² or more, or 5 m² or more, or 7 m² or more, or 9 m² or more.

Meanwhile, the area of the first main surface 11a and that of the second main surface 11b are each preferably 12 m² or less. In cases when the area thereof is 12 m² or less, the strengthened glass sheet is easy to handle and can be inhibited from being damaged, for example, by contact with peripheral members when installed. The area thereof may be 10 m² or less.

In the strengthened glass sheet 10 according to one embodiment of the present invention, the first main surface 11a and the second main surface 11b are each preferably rectangular. In cases when the main surfaces are rectangular, the strengthened glass sheet 10 is easy to install as a window of a building, an external wall, a handrail material, or the cover glass of a solar cell. The term “rectangular” means the shape of an approximately right-angled quadrilateral in which if the distance between any side and the opposed side is measured, the errors due to measuring position are within 0.3% for both the longer sides and the shorter sides. The shape may be one in which the corners have a curvature, cutouts, etc.

In cases when the first main surface 11a and the second main surface 11b of the strengthened glass sheet 10 according to one embodiment of the present invention are rectangular, the length b of each longer side of the main surfaces 11a and 11b may be 50 mm or more, or 100 mm or more, or 300 mm or more, or 500 mm or more, or 1,000 mm or more, or 2,000 mm or more, or 2,500 mm or more. The length b of each longer side of the first main surface 11a and second main surface 11b may be 5,000 mm or less. The length b of each longer side is the minimum distance b between the two opposed shorter sides, as shown in FIG. 2.

In cases when the first main surface 11a and the second main surface 11b of the strengthened glass sheet 10 according to one embodiment of the present invention are rectangular, the length a of each shorter side of the main surfaces 11a and 11b may be 5 mm or more, or 10 mm or more, or 50 mm or more, or 100 mm or more, or 500 mm or more, or 1,000 mm or more, or 2,000 mm or more. The length a of each shorter side of the first main surface 11a and second main surface 11b may be 3,000 mm or less. The length a of each shorter side is the minimum distance a between the two opposed longer sides, as shown in FIG. 2.

The strengthened glass sheet 10 according to one embodiment of the present invention may have a sheet thickness of 0.5 mm or more, from the standpoints of strength, handleability, etc. The sheet thickness thereof may be 1 mm or more, or 2 mm or more, or 3 mm or more, or 5 mm or more. Meanwhile, the sheet thickness thereof is preferably 25 mm or less, because this makes the strengthened glass sheet 10 lightweight. The sheet thickness thereof is more preferably 22 mm or less, still more preferably 19 mm or less.

The strengthened glass sheet 10 according to one embodiment of the present invention preferably has a weight of 1,000 kg or less. This is because the strengthened glass sheet 10 having a weight of 1,000 kg or less is lightweight. The weight thereof is more preferably 500 kg or less. Meanwhile, the weight thereof is preferably 2 kg or more from the standpoints of strength, etc. The weight thereof is more preferably 5 kg or more, still more preferably 10 kg or more.

Functional films such as a heat reflection film and an antifouling film may be formed on the first main surface 11a and/or the second main surface 11b of the strengthened glass sheet 10 according to one embodiment of the present invention.

The strengthened glass sheet 10 according to one embodiment of the present invention preferably has a glass transition point Tg of 530° C. or more. This can inhibit the surface compressive stress formed by ion exchange from relaxing. The glass transition point Tg thereof is more preferably 540° C. or more.

The strengthened glass sheet 10 according to one embodiment of the present invention preferably has a specific gravity of 2.45-2.55.

Symbol “-” indicating the numerical range is used in the sense of including the numerical values set forth before and after the “-” as a lower limit value and an upper limit value. Unless otherwise indicated, “-” is used hereinafter in the same sense.

It is preferable that the strengthened glass sheet 10 according to one embodiment of the present invention as a whole has evenness in specific gravity. The expression “the strengthened glass sheet 10 as a whole has evenness in specific gravity” means that the difference between the specific gravity of a portion of the strengthened glass sheet 10 lying from the end surface 12 to a depth not larger than 1/10 the sheet thickness and the specific gravity of a portion of the strengthened glass sheet 10 lying in the center of the main surface 11a or 11b from the main surface 11a or 11b to a depth not larger than 1/10 the sheet thickness is in the range of −0.50% to 0.00% with respect to the specific gravity of the portion of the strengthened glass sheet 10 lying in the center of the main surface 11a or 11b from the main surface 11a or 11b to the depth not larger than 1/10 the sheet thickness. The specific gravity can be estimated by measuring surface fictive temperatures by any desired method, e.g., Raman spectrometry.

The strengthened glass sheet 10 according to one embodiment of the present invention preferably has a Young's modulus of 65 GPa or more. This renders the rigidity and the fracture toughness sufficient. The Young's modulus thereof may be 70 GPa or more. Meanwhile, in cases when the Young's modulus thereof is 90 GPa or less, the strengthened glass sheet can be inhibited from being brittle and be inhibited from chipping when machined or diced. The Young's modulus thereof may be 85 GPa or less, or 80 GPa or less.

The strengthened glass sheet 10 according to one embodiment of the present invention preferably has an average coefficient of thermal expansion at 50-350° C. of 30×10⁻⁷/° C. to 140×10⁻⁷/° C. In cases when the average coefficient of thermal expansion thereof at 50-350° C. is 30×10⁷/° C. or more, a strengthened portion 30 can be formed in the end surface strengthening step, which will be described later, even when the temperature T2 of the end surface of the glass sheet 10 during irradiation with laser light 60 in the step is lower than the softening point of the glass sheet 10. The average coefficient of thermal expansion thereof at 50-350° C. is more preferably 60×10⁻⁷/° C. or more, still more preferably 80×10⁷/° C. or more, especially preferably 85×10⁻⁷/° C. or more. Meanwhile, in cases when the average coefficient of thermal expansion thereof at 50-350° C. is 140×10⁷/° C. or less, a temperature difference which occurs between a portion that is being irradiated with laser light 60 in the end surface strengthening step and a portion that is not being irradiated does not result in too high stress and the strengthened glass sheet 10 hence is less apt to break. The average coefficient of thermal expansion thereof at 50-350° C. is more preferably 100×10⁷/° C. or less, still more preferably 95×10⁻⁷/° C. or less.

It is preferable that the strengthened glass sheet 10 according to one embodiment of the present invention includes, in mole percentage on an oxide basis, 0.003-1.5% Fe₂O₃, 56-75% SiO₂, 0-20% Al₂O₃, 8-22% Na₂O, 0-10% K₂O, 0-14% MgO, 0-5% ZrO₂, and 0-12% CaO. Hereinafter, each content given in percent is content in mole percentage on an oxide basis unless otherwise indicated.

Reasons for limiting the glass composition of the strengthened glass sheet 10 according to one embodiment of the present invention to the ranges shown above are explained below.

Fe₂O₃ is preferably contained in cases when a near-infrared laser is used in the end surface processing which will be described later. Fe²⁺ ions in glass absorb laser light having a wavelength of 1,000-1,100 nm. In cases when the content of Fe₂O₃ is 0.003% or more, the end surface can be efficiently heated with such laser light. The content of Fe₂O₃ is more preferably 0.005% or more, still more preferably 0.01% or more, especially preferably 0.02% or more, most preferably 0.05% or more. In cases when the content of Fe₂O₃ is 1.5% or less, the laser light is less apt to be absorbed by the glass surface and is easy to condense in an inner portion of the glass. The content of Fe₂O₃ is more preferably 1.0% or less, still more preferably 0.5% or less, yet still more preferably 0.3% or less, especially preferably 0.2% or less, most preferably 0.1% or less.

In the case of utilizing laser light other than near-infrared laser light, it is preferable that an appropriate absorber ingredient according to the wavelength of the laser light is incorporated into the glass in an appropriate amount. Since absorption of light having a wavelength in the visible-light region necessitates coloring of the glass, a colored glass may be used for end surface strengthening with a visible-light laser.

SiO₂ is a component which forms a network structure in the microstructure of the glass, and is a major component for constituting the glass. The content of SiO₂ is preferably 56% or more, more preferably 63% or more, still more preferably 66% or more, especially preferably 68% or more. Meanwhile, the content of SiO₂ is preferably 75% or less, more preferably 73% or less, still more preferably 72% or less. In cases when the content of SiO₂ is 56% or more, the glass is advantageous in terms of stability and weatherability. Meanwhile, in cases when the content of SiO₂ is 75% or less, the glass is advantageous in terms of meltability and formability.

Al₂O₃, although not essential, serves to improve the ion exchange performance for chemical strengthening and is highly effective especially in enhancing the CS. Al₂O₃ may hence be incorporated. Al₂O₃ further serves to improve the weatherability of the glass. The content of Al₂O₃, when it is contained, is preferably 0.4% or more, more preferably 0.6% or more, still more preferably 0.8% or more. Al₂O₃ reduces the refractive index and lowers the reflectance. In cases when the content of Al₂O₃ is 20% or less, the glass does not have a considerably elevated devitrification temperature even when having high viscosity. The glass having an Al₂O₃ content of 20% or less is hence advantageous in terms of melting and forming in soda-lime glass production lines. The content of Al₂O₃ is more preferably 10% or less, still more preferably 5% or less, especially preferably 3% or less, most preferably 2% or less.

The total content of SiO₂ and Al₂O₃ (hereinafter referred to also as “SiO₂+Al₂O₃ content”) is preferably 68% or more. In cases when the SiO₂+Al₂O₃ content is 68% or more, the glass has improved crack resistance upon reception of an indentation. Furthermore, the glass has a reduced refractive index and a lowered reflectance. The SiO₂+Al₂O₃ content is more preferably 70% or more. Meanwhile, the SiO₂+Al₂O₃ content is preferably 80% or less. In cases when the SiO₂+Al₂O₃ content is 80% or less, the glass has reduced viscosity at high temperatures and is easy to melt. The SiO₂+Al₂O₃ content is more preferably 76% or less, still more preferably 74% or less.

Na₂O is a component for forming surface compressive stress through ion exchange and serves to increase the DOL. Na₂O is also a component which reduces the high-temperature viscosity and devitrification temperature of the glass and improves the meltability and formability of the glass. The content of Na₂O is preferably 8% or more, more preferably 10% or more, still more preferably 12% or more. Meanwhile, the content of Na₂O is preferably 22% or less, more preferably 16% or less, still more preferably 14% or less. In cases when the content of Na₂O is 8% or more, it is easy to form desired surface compressive stress by ion exchange. Meanwhile, in cases when the content of Na₂O is 22% or less, sufficient weatherability is obtained.

K₂O has the effects of heightening the rate of ion exchange and increasing the DOL, and hence may be contained. Meanwhile, too high K₂O contents make it impossible to obtain a sufficient CS. The content of K₂O, when it is contained, is preferably 10% or less, more preferably 2% or less, still more preferably 1% or less. In cases when the content of K₂O is 10% or less, a sufficient CS is obtained.

MgO, although not essential, is a component which stabilizes the glass. The content of MgO, when it is contained, is preferably 2% or more, more preferably 4% or more, still more preferably 6% or more. Meanwhile, the content of MgO is preferably 14% or less, more preferably 10% or less, still more preferably 8% or less. In cases when the content of MgO is 2% or more, the glass has satisfactory chemical resistance. This glass has satisfactory meltability at high temperatures and is less apt to devitrify. Meanwhile, in cases when the content of MgO is 14% or less, the unsusceptibility to devitrification is maintained and a sufficient rate of ion exchange is obtained.

ZrO₂ is a component which increases the refractive index, and it is preferable that substantially no ZrO₂ is contained from the standpoints of reducing the refractive index and lowering the reflectance. In this description, the expression “containing substantially no X” means that the glass does not contain X other than that which has come thereinto as unavoidable impurities contained in raw materials, etc. Namely, the expression means that X has not been purposely incorporated. However, ZrO₂ may be incorporated because it serves to increase the CS of the chemically strengthened glass. The content of ZrO₂, when it is contained, is preferably 5% or less, more preferably 3% or less, still more preferably 1% or less.

CaO, although not essential, is a component which stabilizes the glass. The content of CaO, when CaO is contained, is preferably 2% or more, more preferably 5% or more, still more preferably 7% or more. Meanwhile, the content of CaO is preferably 12% or less, more preferably 10% or less, still more preferably 9% or less. In cases when the content of CaO is 2% or more, the glass has satisfactory chemical resistance. In cases when the content of CaO is 12% or less, a sufficient rate of ion exchange is maintained and a desired DOL is obtained.

SrO, although not essential, may be contained for reducing the high-temperature viscosity of the glass and lowering the devitrification temperature thereof. SrO serves to reduce the efficiency of ion exchange and it is hence preferable that SrO is not contained especially in cases when an increase in DOL is desired. The content of SrO, when it is contained, is preferably 3% or less, more preferably 2% or less, still more preferably 1% or less.

BaO, although not essential, may be contained for reducing the high-temperature viscosity of the glass and lowering the devitrification temperature thereof. BaO serves to increase the specific gravity of the glass and it is hence preferable that BaO is not contained in cases when a weight reduction is desired. The content of BaO, when it is contained, is preferably 3% or less, more preferably 2% or less, still more preferably 1% or less.

ZnO, when a glass sheet is formed by a float process, is reduced by the float bath, resulting in product defects. It is hence preferable that substantially no ZnO is contained.

Besides including those components, the glass may suitably contain a sulfuric acid salt, a chloride, a fluoride, or the like as a refining agent for glass melting.

Although the strengthened glass sheet of the present invention is essentially configured of the components explained above, the strengthened glass sheet may contain other components so long as the inclusion thereof does not defeat the object of the present invention. In cases when the strengthened glass sheet contains such components, the total content thereof is preferably 5% or less, more preferably 3% or less, typically 1% or less. Examples of the other components are explained below.

B₂O₃ may be contained in an amount less than 1%, for improving high-temperature meltability or glass strength. In general, in case where B₂O₃ is contained simultaneously with an alkali component such as Na₂O or K₂O, the B₂O₃ volatilizes vigorously to severely erode the bricks. It is hence preferable that substantially no B₂O₃ is contained.

Li₂O is a component which lowers the strain point to promote stress relaxation and thereby make it impossible to obtain stable surface compressive stress. It is hence preferable that Li₂O is not contained. Even if Li₂O is contained, the content thereof is preferably 1% or less, more preferably 0.05% or less, especially preferably 0.01% or less.

A method of producing the strengthened glass sheet 10 according to one embodiment of the present invention is explained next.

In the case of producing the strengthened glass sheet 10 according to one embodiment of the present invention, the strengthened glass sheet 10 is produced through a glass sheet production step, a chemical strengthening treatment step, and an end surface strengthening step.

In the glass sheet production step, a glass sheet is produced, for example, by mixing appropriate amounts of various raw materials, heating the mixture at about 1,400-1,800° C. to melt the mixture, thereafter homogenizing the melt by defoaming, stirring, etc., forming the homogenized melt into a sheet shape by a known process, such as a float process, downdraw process, rolling-out process, or pressing process, annealing the sheet, and then cutting the cooled sheet into a desired size.

In the chemical strengthening treatment step, at least one of the main surfaces of the obtained glass sheet is immersed in a molten salt to form desired surface compressive stress in the main surface. In the chemical strengthening treatment step, the glass sheet undergoes a preheating step, a chemical strengthening step, and an annealing step.

In the preheating step, the glass sheet is preheated before being subjected to a chemical strengthening treatment. The preheating is conducted, for example, by introducing the glass sheet into an electric furnace having ordinary temperature, heating the electric furnace to a preheating temperature, and holding the glass sheet at the temperature for a certain time period. It is preferable that after termination of the heating, the glass sheet is held at the preheating temperature for a certain time period in order to prevent the glass sheet from breaking due to thermal shock in the chemical strengthening step. The holding period is preferably 10 minutes or longer, more preferably 20 minutes or longer, still more preferably 30 minutes or longer, especially preferably 40 minutes or longer.

In the chemical strengthening treatment step, the preheated glass sheet is immersed in a molten salt, e.g., a heated potassium-nitrate molten salt, to cause ion exchange between Na in a surface layer of the glass and K in the molten salt. In the present invention, examples of the potassium-nitrate molten salt include not only KNO₃ and KNO₂ but also one containing up to 10 mass % NaNO₃.

Conditions for the chemical strengthening treatment for forming desired surface compressive stress in the glass sheet vary depending on the sheet thickness of the glass sheet, etc. However, under typical conditions, the glass sheet is immersed for 2-50 hours in a molten salt, e.g., a potassium-nitrate molten salt, having a temperature of 350-550° C. From the standpoint of profitability, preferred conditions are such that the glass sheet is immersed at 350-500° C. for 2-40 hours, and a more preferred immersion period is 2-30 hours.

In the annealing step, the glass sheet taken out of the molten salt is annealed. It is preferable that the glass sheet which has been taken out of the molten salt is not immediately subjected to annealing but is held at an even temperature for a certain time period in order to make the main surface of the glass sheet less apt to have a temperature distribution therein.

The temperature at which the glass sheet is held is such that the difference between this temperature and the temperature of the molten salt is preferably 100° C. or less, more preferably 50° C. or less, still more preferably 20° C. or less, especially preferably 10° C. or less. The holding period is preferably 10 minutes or longer, more preferably 20 minutes or longer, still more preferably 30 minutes or longer.

The glass sheet taken out of the molten salt is preferably annealed so that the rate of annealing to 100° C. is 300° C./hr or less. The rate of annealing is more preferably 200° C./hr or less, still more preferably 100° C./hr or less.

The chemical strengthening treatment step may be conducted after the end surfaces 12 are chamfered, or the end surfaces 12 may be chamfered after the chemical strengthening treatment step. Alternatively, the end surfaces 12 may not be chamfered.

The production method may include, after the chemical strengthening treatment step, a cutting step in which the glass sheet that has been chemically strengthened is cut. The inclusion of the cutting step after the chemical strengthening treatment step improves the production efficiency. By cutting the chemically strengthened glass sheet after the chemical strengthening treatment step, a glass sheet can be obtained in which the end surfaces 12 do not have the surface compressive stress due to the chemical strengthening treatment.

In the cutting step, the glass sheet may be cut by cutting the glass sheet after thermal-stress scribing with a laser or a gas burner. In cases when the glass sheet is cut after thermal-stress scribing, microcracks are less apt to occur. In addition, the scattering of laser light in the end surface strengthening step can be reduced.

In the end surface strengthening step, planar compressive stress is formed along an end surface of the glass sheet, in which main surface has surface compressive stress formed therein in the chemical strengthening treatment step, in a direction parallel with the end surface.

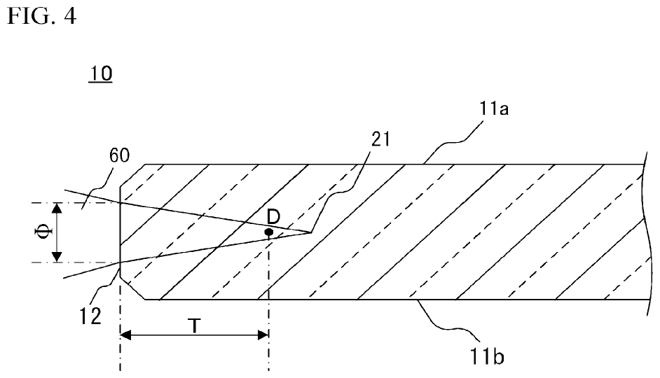

FIG. 4 is a cross-sectional view of the strengthened glass sheet which is being irradiated with laser light in the end surface strengthening step.

In the end surface strengthening step, an inner portion of the glass sheet 10 is heated, for example, by irradiating an end surface 12 of the glass sheet with laser light 60. Thereafter, the inner portion of the glass sheet 10 is cooled later than the end surface 12 of the glass sheet 10, thereby forming tensile stress in the inner portion of the glass sheet 10. At this time, a compressive stress region corresponding to the tensile-stress region formed in the inner portion of the glass sheet 10 is formed, due to a stress balance, in the end surface 12 of the glass sheet. Thus, the end surface 12 can be strengthened.

In the end surface strengthening step, the glass sheet 10 is heated during the irradiation with the laser light 60 so that a portion of the glass sheet 10 lying in position D at a distance from the end surface along a direction normal to the end surface, the distance D being equal to the thickness of the glass sheet 10, has a temperature T1 which is not lower than a strain point of the glass sheet 10. Since the temperature T1 of the portion in position D is not lower than the strain point of the glass sheet 10, the end surface 12 is sufficiently strengthened.

In the end surface strengthening step, the end surface 12 of the glass sheet 10 during the irradiation with the laser light 60 has a temperature T2 which is lower than a softening point of the glass sheet 10, and T1>T2 is satisfied. Since the temperature of the end surface 12 is lower than the softening point of the glass sheet 10 and T1>T2 is satisfied, tensile stress is not formed thereafter in the end surface 12. If the temperature of the end surface 12 is such that T1<T2, then tensile stress can generate thereafter in some of the end surface 12. In case where the temperature of the end surface 12 is not lower than the softening point, the end surface suffers a deformation. During the irradiation with the laser light 60, the temperature T2 of the end surface 12 of the glass sheet 10 is preferably not higher than the annealing point of the glass sheet 10, more preferably not higher than the strain point of the glass sheet 10.

In the end surface strengthening step, during the irradiation with the laser light 60, the first main surface 11a and the second main surface 11b of the glass sheet 10 each preferably have a temperature of 300° C. or less. In cases when the temperatures of the first main surface 11a and second main surface 11b of the glass sheet 10 are 300° C. or less, the glass sheet 10 can be inhibited from deforming. In addition, the diffusion of ions can be inhibited and the first main surface 11a and the second main surface 11b can be inhibited from decreasing in strength. During the irradiation with the laser light 60, the temperatures of the first main surface 11a and second main surface 11b of the glass sheet 10 are more preferably 200° C. or less, still more preferably 100° C. or less.

In the end surface strengthening step, the laser light 60 is caused to enter an inner portion of the glass sheet 10 through the end surface 12 of the glass sheet 10. Thus, the inner portion of the glass sheet 10 which lies over a wide range can be heated and the strengthening of the end surface 12 can be promoted.

It is preferable that not only the end surface 12 of the glass sheet 10 is irradiated with the laser light 60 but also the laser light 60 is condensed in an inner portion of the glass sheet 10. By disposing a light condensing point 21 of the laser light 60 in an inner portion of the glass sheet 10, the inner portion of the glass 10 is made to have a higher temperature than the surfaces of the glass sheet 10.

By irradiating the glass sheet 10 with the laser light 60, linear absorption is mainly caused. The expression “linear absorption mainly occurs” means that the quantity of heat generated by linear absorption is larger than the quantity of heat generated by nonlinear absorption. Nonlinear absorption may occur little.

Nonlinear absorption is also called multiphoton absorption. The probability of the occurrence of multiphoton absorption is nonlinear with respect to the photon density (power density of the laser light 60); the higher the photon density, the remarkably higher the probability becomes. For example, the probability of the occurrence of two-photon absorption is proportional to the square of photon density.

According to a finding made by the present inventors, it is preferable, in the case of the glass sheet 10, that the photon density is 1×10⁸ W/cm² or more for causing nonlinear absorption which is effective in forming tensile stress in an inner portion of the glass sheet 10.

At any position in the glass sheet 10, the photon density may be less than 1×10⁸ W/cm². In this case, substantially no nonlinear absorption occurs. Since the cross-sectional size of the laser light 60 is larger than the wavelength, the size of the light condensing point 21 is not zero and the photon density in the light condensing point may be less than 1×10⁸ W/cm².

Meanwhile, linear absorption is also called one-photon absorption. The probability of the occurrence of one-photon absorption is proportional to photon density. In the case of one-photon absorption, the intensity of the laser light 60 attenuates in accordance with Lambert-Beer's law.

If the intensity of the laser light 60 has changed from I₀ to I during the period when the laser light 60 has traveled in the glass sheet 10 over a distance E (unit [cm]), then the equation I=I₀×exp(−α×E) holds, where a is a constant called the absorption coefficient (unit [cm⁻¹]) of the glass sheet 10. The absorption coefficient α is determined with an ultraviolet/visible/near-infrared spectrophotometer, etc.

The absorption coefficient α may be less than, for example, 100. In cases when the absorption coefficient α is 100 or more, the laser light 60 is mostly absorbed in the vicinity of the surface of the glass sheet 10, making it difficult to heat an inner portion of the glass sheet 10. The absorption coefficient α is preferably less than 30, more preferably less than 10. In general, the absorption coefficient α is larger than 0. The absorption coefficient α depends on the wavelength of the laser light 60, the glass composition of the glass sheet 10, etc. It is preferred to irradiate the glass sheet 10 with laser light having such a wavelength that the absorption coefficient α is less than 100.

The wavelength of the laser light 60, although depending on the glass composition of the glass sheet 10, etc., may be, for example, 250-5,000 nm. In cases when the wavelength of the laser light 60 is 250-5,000 nm, the absorption coefficient α is in an appropriate range.

Examples of light sources for the laser light 60 include near-infrared lasers such as a Yb fiber laser (wavelength: 1,000-1,100 nm), a Yb disk laser (wavelength: 1,000-1,100 nm), an Nd:YAG laser (wavelength: 1,064 nm), and high-output semiconductor lasers (wavelength: 808-980 nm).

Also usable as light sources for the laser light 60 are a UV laser (wavelength: 355 nm), a green laser (wavelength: 532 nm), an Ho:YAG laser (wavelength: 2,080 nm), a Er:YAG laser (2,940 nm), lasers (wavelength: 2,600-3,450 nm) employing a mid-infrared parametric oscillator, etc.

Such light sources for the laser light 60 may be of the pulse oscillation type but are preferably of the continuous oscillation type. In the case of the continuous oscillation type, an inner portion of the glass sheet 10 can be heated over a wide range.

The laser light 60 may be composed of a plurality of beams, although FIG. 4 shows one beam. A plurality of beams of the laser light 60 may be caused to simultaneously strike on the glass sheet 10.

In the end surface strengthening step, the glass sheet 10 is irradiated with laser light 60 to mainly cause linear absorption and to heat an inner portion of the glass sheet 10 to a higher temperature than the end surface 12 of the glass sheet 10, thereby forming tensile stress and strengthening the end surface 12 of the glass sheet 10. By mainly causing linear absorption, an inner portion of the glass sheet 10 can be heated over a wider range and the strengthening of the end surface 12 can be more promoted, than in the case of mainly causing nonlinear absorption. Furthermore, since the inner portion of the glass sheet 10 is heated to a higher temperature than the end surface 12 of the glass sheet 10, planar tensile stress is less apt to be formed in the strengthened portion 30 and the glass sheet 10 can be inhibited from suffering thermal cracking occurring from the heated portion.

In the end surface strengthening step, the position of an area being irradiated with the laser light 60 is moved along the end surface 12 of the glass sheet 10, thereby forming a strengthened portion 30 along the periphery of the glass sheet 10. The strengthened portion 30 may be continuously formed along at least some of the periphery of the glass sheet 10, or may be formed along the whole periphery of the glass sheet 10.

The movement of the position of an area being irradiated with the laser light 60 on the glass sheet 10 is attained by moving the glass sheet 10 or the light source for the laser light 60 or by moving both. The position of an area being irradiated with the laser light 60 on the glass sheet 10 may be moved by operating a Galvano mirror.

The position where irradiation with the laser light 60 is initiated is preferably such that the center of the shape of an area in the end surface 12 of the glass sheet 10 which is being irradiated with the laser light 60 lies inside the edge of the glass sheet 10. In cases when the position where irradiation with the laser light 60 is initiated lies inside the edge of the glass sheet 10, the glass sheet 10 is less apt to break and the production equipment is less apt to suffer burning.

The shape of an area irradiated with the laser light 60 in the end surface 12 of the glass sheet 10 may be a linear shape extending along the moving direction of the laser light 60 on the glass sheet 10. In this case, the moving-direction powder distribution of the laser light 60 on the glass sheet 10 may be a top-hat distribution or a Gauss distribution. In cases when the shape of the area irradiated with the laser light 60 in the end surface 12 is linear, the glass sheet 10 has a gentle temperature change and can be inhibited from suffering thermal breakage in the end surface strengthening step.

The shape of an area being irradiated with the laser light 60 in the end surface 12 of the glass sheet 10 may have a sheet-thickness-direction width P (see FIG. 4) not larger than the thickness of the glass sheet 10. In cases when the area being irradiated with the laser light 60 in the end surface 12 of the glass sheet 10 has a shape having a sheet-thickness-direction width (I) not larger than the thickness of the glass sheet 10, portions of the main surfaces 11a and 11b which lie in the vicinity of the end surface 12 can be inhibited from being heated and the surface compressive stress formed by the chemical strengthening treatment in those portions of the main surfaces 11a and 11b lying in the vicinity of the end surface 12 can be inhibited from decreasing.

The position of the sheet-thickness-direction center of the power distribution of the laser light 60 on the glass sheet 10 may coincide with the center of the sheet thickness. In cases when the position of the sheet-thickness-direction center of the power distribution coincides with the center of the sheet thickness, the end surface strengthening step can be effectively conducted. In addition, the coincidence with the center of the sheet thickness renders the glass sheet 10 less apt to warp after the end surface strengthening. The expression “coincidence with the center of the sheet thickness” means that the position of the sheet-thickness-direction center of the power distribution of the laser light 60 may completely coincide with the center of the sheet thickness or may be offset from the center of the sheet thickness up to ±30% of the sheet thickness, or up to ±15% of the sheet thickness. In order to perform control for making the position of the sheet-thickness-direction center of the power distribution of the laser light 60 coincide with the center of the sheet thickness, the surface of the glass sheet 10 may be examined with, for example, a distance sensor.

It is preferable that in preparation for the irradiation of the end surface 12 of the glass sheet 10 with the laser light 60, the main surfaces of the glass sheet 10 are fixed with jigs or the like. By fixing the main surfaces of the glass sheet 10, the glass sheet 10, even when having expanded due to the irradiation with the laser light 60, is inhibited from deforming and from becoming offset from the position of being irradiated with the laser light 60. Hence, the laser light 60 can be caused to strike on a desired position on the glass sheet 10. Although it is preferable that the main surfaces of the glass sheet 10 are entirely fixed with jigs, only some of the main surfaces of the glass sheet 10 may have been fixed. In the case of fixing some of the main surfaces of the glass sheet 10, it is preferred to dispose jigs at certain intervals on the main surfaces of the glass sheet 10, and the intervals may be 250 mm or less.

For the jigs, it is preferable to use a material having a low thermal conductivity as the portions coming into contact with the glass sheet 10. In cases when a material having a low thermal conductivity is used, thermal stress is less apt to occur in surface portions of the glass sheet 10 which are in contact with the jigs and the glass sheet 10 is less apt to break. Examples of the material having a low thermal conductivity include MC Nylon and fluororesin.

It is preferable that the intensity and moving speed of the laser light 60 are decided after the absorption coefficient α of the glass sheet 10 is determined beforehand. The larger the absorption coefficient α, the lower the intensity of the laser light 60 is preferably set and the higher the moving speed of the laser light 60 is preferably set. In case where the intensity of the laser light 60 is too high, the glass sheet 60 is prone to break.

In the end surface strengthening step, any of a gas, e.g., compressed air, a liquid, e.g., a mist, and a mixture of these may be blown against the glass sheet 10. This can inhibit the surfaces of the glass sheet 10 from increasing in temperature. Furthermore, a temperature difference between the surfaces of the glass sheet 10 and an inner portion of the glass sheet 10 can be ensured and milder conditions can be used for the irradiation with the laser light 60. In addition, any foreign substances, such as dust particles, adherent to the surfaces of the glass sheet 10 can be removed. In cases when the laser light 60 strikes on such foreign substances, the foreign substances can absorb some of the laser light 60.

After the end surface strengthening step, a protective layer may be formed on the end surface 12.

In the strengthened glass sheet according to this embodiment described above, the main surfaces and the end surface each have high strength. This strengthened glass sheet hence is less apt to break.

The present invention is not limited to the embodiment described above. Modifications, improvements, and the like made in such a manner that the object of the present invention can be achieved are included in the present invention.

In the embodiment described above, a configuration of the end surface strengthening step was shown as an example in which an inner portion of the glass sheet 10 was heated by irradiating the end surface 12 of the glass sheet with laser light 60. However, an inner portion of the glass sheet 10 may be heated with an infrared heater or microwaves to strengthen the end surface 12.

### EXAMPLES

The present invention is explained in detail below by reference to Examples, but the present invention is not limited to the following Examples.

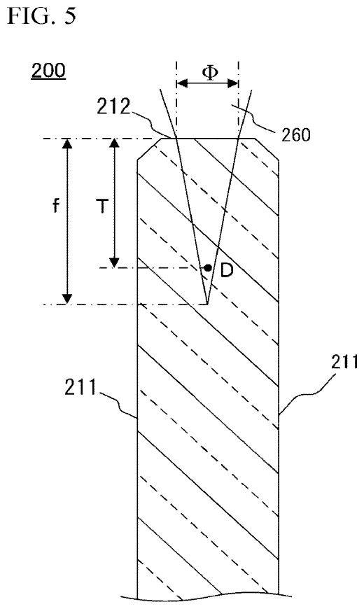

FIG. 5 is a cross-sectional view illustrating the strengthened glass sheet 200 of a Working Example.

Examples 1, 3, and 5 are Working Examples, and Examples 2, 4, and 6 are Comparative Examples.

Various raw materials for glass, such as silica sand, were mixed so as to result in the glass composition shown in Table 1, and the mixture was then melted at a temperature of 1,400-1,500° C. The obtained molten glass was formed by a float process into a sheet shape having each of the thicknesses T shown in Table 2, and the formed glass was cut to obtain a rectangular glass sheet.

The obtained glass sheet was examined for glass transition point Tg (unit: ° C.), specific gravity, Young's modulus (unit: GPa), and average coefficient of thermal expansion (unit: 10⁻⁷/° C.). The results thereof are shown in Table 1.

Methods used for determining the properties of the glass sheet are shown below.

### (Glass Transition Point Tg)

A differential thermodilatometer (TMA) was used to make a measurement in accordance with the method specified in JIS R3103-3 (2001).

### (Specific Gravity)

A mass of glass weighing about 20 g and containing no bubble was examined by Archimedes' method.

### (Young's Modulus)

Young's modulus was determined by an ultrasonic pulse method.

### (Average Coefficient of Thermal Expansion)

A differential thermodilatometer (TMA) was used to make a measurement in accordance with the method specified in JIS R3102 (1995). The measurement temperature range was 50-350° C.

### Example 1

The obtained glass sheet was cut with a wheel cutter so as to result in the shorter-side length a and longer-side length b shown in Table 2 and then subjected to C-chamfering. The chamfered glass sheet was chemically strengthened by immersion in a potassium-nitrate molten salt, thereby obtaining a strengthened glass sheet. A main surface of the obtained strengthened glass sheet was examined for CS and DOL. The CS and the DOL were calculated from the number of and the spacing between interference fringes observed using a surface stress meter (FSM-7000H, manufactured by Orihara Industrial C., Ltd.). For the calculations, the refractive index and photoelastic constant of the strengthened glass sheet were taken as 1.518 and 27.1 [(nm/cm)/MPa], respectively. The results of the determination of CS and DOL of the main surface are shown in Table 2.

As shown in FIG. 5, the main surface 211 of the obtained strengthened glass sheet 200 was fixed with jigs so that an end surface 212 of the glass sheet faced upward, and the end surface 212 was irradiated with laser light 260 from above from a direction perpendicular thereto so that the laser light 260 was condensed in an inner portion of the strengthened glass sheet 200. Thus, a strengthened portion having planar compressive stress formed therein was formed along the end surface 212.

As a light source for the laser light 260 was used a fiber laser having a wavelength (1,070 nm) which mainly caused linear absorption. The position irradiated with the laser light 260 lay in a sheet-thickness-direction center portion of the end surface 212 of the strengthened glass sheet 200, and the position being irradiated was moved in the longitudinal direction of the strengthened glass sheet 200 at a moving speed of 10.0 mm/sec. The area in the end surface 212 of the glass sheet 200 which was irradiated with the laser light 260 had a shape having a width of 2 mm and a length of 100 mm. The position where irradiation with the laser light 260 was initiated was such that the center of the shape of the area in the end surface 212 of the glass sheet 200 which was being irradiated with the laser light 260 lay inside the edge of the glass sheet 200, on the end surface 212 of the glass sheet 200.

The width-direction depth f of the light condensing point (see FIG. 5) from the end surface 212 of the strengthened glass sheet 200 was 56.8 mm, and the power P (not shown) of the light source for the laser light 260 was 1,300 W. The glass sheet had an absorption coefficient of 0.57 [1/cm].

As a result of the irradiation with the laser light 260, a portion lying in position D at a distance from the end surface 212 of the strengthened glass sheet 200 along a direction normal to the end surface 212, the distance being equal to the thickness of the strengthened glass sheet 200, has a temperature not lower than the strain point of the strengthened glass sheet 200. The end surface 212 of the glass sheet 10 had a temperature of 607° C. Since the glass sheet 10 had a softening point of 730° C., the temperature of the end surface 212 was lower than the softening point and T1>T2 held.

The strengthened portion of the strengthened glass sheet 200 of Example 1 had a maximum value of planar compressive stress of 22.1 MPa and had a width C, as measured from the end surface 212, of 2.7 mm. The width C was 0.5 times or more the thickness T of the glass sheet 200. The strengthened portion had no planar tensile stress therein. The planar compressive stress of the strengthened portion was determined with a two-dimensional birefringence distribution analyzer (WPA-100, manufactured by Photonic Lattice, Inc.).

By the method shown above, fifteen strengthened glass sheets 200 were prepared. The fifteen strengthened glass sheets 200 were examined for four-point bending strength in such a manner that each strengthened glass sheet 200 which was held so that the end surface 212 irradiated with the laser light 260 faced downward was bent so as to protrude downward. The obtained values were averaged to determine an average fracture stress. Furthermore, Weilbull plotting was conducted in accordance with JIS R 1625 (1996) to determine a Weilbull coefficient. The upper span and the lower span were 20 mm and 60 mm, respectively, and the head speed was 1 mm/min. As a result, the average fracture stress was found to be 346 MPa. Moreover, the strengthened glass sheets 200 had a 0.1% fracture probability strength of 259 MPa, which was determined on the assumption that the logarithm of the fracture stresses gave a normal distribution, and had a Weilbull coefficient of 12.3.

### Example 2

Eighteen strengthened glass sheets 200 were prepared in the same manner as in Example 1, but the end surfaces 212 were not irradiated with the laser light 260. The strengthened glass sheets 200 were subjected to the four-point bending test in the same manner as in Example 1. As a result, strengthened portions had a maximum value of planar compressive stress of 1.9 MPa and had a width C, as measured from the end surface 212, of 0.77 mm. The width C was less than 0.5 times the thickness T of the glass sheets 200. The strengthened glass sheets 200 had an average fracture stress of 311 MPa. Furthermore, the strengthened glass sheets 200 had a 0.1% fracture probability strength, which was determined on the assumption that the logarithm of the fracture stresses gave a normal distribution, of 122 MPa and a Weilbull coefficient of 3.6.

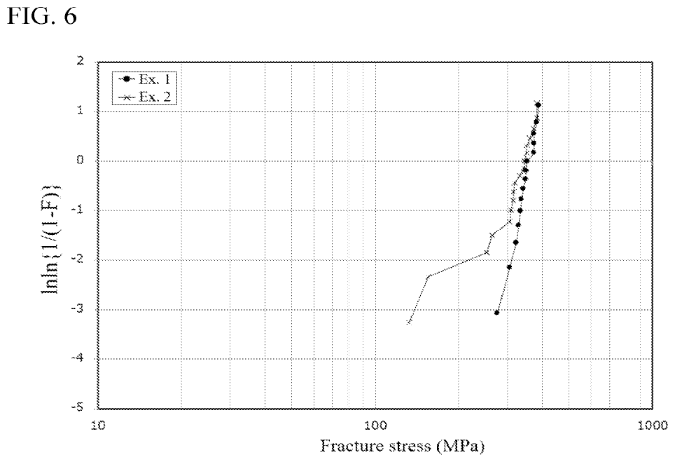

The Weilbull plots of Examples 1 and 2 are shown in FIG. 6. A comparison between the results of the four-point bending test in Example 1 and those in Example 2 shows that the average fracture stress and Weilbull coefficient of Example 1, in which end surface irradiation with laser light had been conducted, were higher than the average fracture stress and Weilbull coefficient of Example 2, in which end surface irradiation with laser light had not been conducted. Furthermore, the 0.1% fracture probability strength, which had been determined on the assumption that the logarithm of the fracture stresses gave a normal distribution, of Example 1, in which end surface irradiation with laser light had been conducted, was higher than the 0.1% fracture probability strength, which had been determined on the assumption that the logarithm of the bending strengths gave a normal distribution, of Example 2, in which end surface irradiation with laser light had not been conducted. It was thus demonstrated that the irradiation of an end surface with laser light forms a strengthened portion therein and the end surface can be thereby strengthened.

### Example 3

In the same manner as in Example 1, the molten glass was formed by the float process into a sheet shape to obtain a rectangular glass sheet. The obtained glass sheet was chemically strengthened by immersion in a potassium-nitrate molten salt, thereby obtaining a strengthened glass sheet. The obtained strengthened glass sheet was cut with a wheel cutter so as to result in the shorter-side length a and longer-side length b shown in Table 2 and then subjected to C-chamfering. The chamfered strengthened glass sheets were examined for CS and DOL. The results thereof are shown in Table 2.

Next, an end surface was irradiated with laser light 260 in the same manner as in Example 1, except that the width-direction depth f of the light condensing point (see FIG. 5) from the end surface 212 of the strengthened glass sheet 200 was 30 mm and the power P of the light source for the laser light 260 was 1,600 W.

The strengthened portions of the strengthened glass sheets 200 of Example 3 had a maximum value of planar compressive stress of 62.7 MPa and had a width C, as measured from the end surface 212, of 3.0 mm. The width C was 0.5 times or more the thickness T of the strengthened glass sheets 200. The strengthened portions had no planar tensile stress therein.

The strengthened glass sheets 200 were subjected to the four-point bending test in the same manner as in Example 1. As a result, the average fracture stress was found to be 208 MPa. Furthermore, the 0.1% fracture probability strength, determined on the assumption that the logarithm of the fracture stresses gave a normal distribution, was 159 MPa.

### Example 4

Nineteen strengthened glass sheets were prepared in the same manner as in Example 3, but the end surfaces 212 were not irradiated with the laser light 260. The strengthened glass sheets were subjected to the four-point bending test in the same manner as in Example 3. As a result, strengthened portions had a maximum value of planar compressive stress of 2.1 MPa and had a width C, as measured from the end surface 212, of 0.52 mm. The width C was less than 0.5 times the thickness T of the strengthened glass sheets 200. The average fracture stress was 84 MPa. Furthermore, the 0.1% fracture probability strength, determined on the assumption that the logarithm of the fracture stresses gave a normal distribution, was 66 MPa.

A comparison between the results of the four-point bending test in Example 3 and those in Example 4 shows that the average fracture stress of Example 3, in which end surface irradiation with laser light had been conducted, was higher than the average fracture stress regarding bending strength of Example 4, in which end surface irradiation with laser light had not been conducted. Furthermore, the 0.1% fracture probability strength, determined on the assumption that the logarithm of the fracture stresses gave a normal distribution, of Example 3, in which end surface irradiation with laser light had been conducted, was higher than the 0.1% fracture probability strength, determined on the assumption that the logarithm of the bending strengths gave a normal distribution, of Example 4, in which end surface irradiation with laser light had not been conducted. It was thus demonstrated that the irradiation of an end surface with laser light forms a strengthened portion therein and the end surface can be thereby strengthened.

### Example 5

A strengthened glass sheet was obtained in the same manner as in Example 1. The obtained strengthened glass sheet was subjected to thermal-stress scribing with a laser and then cut, so as to result in the shorter-side length a and longer-side length b shown in Table 2. Thus, ten strengthened glass sheets which had mirror surfaces and had undergone C-chamfering were obtained. The main surfaces 211 of each obtained strengthened glass sheet were fixed with jigs so that an end surface 212 of the glass sheet faced upward, and the end surface 212 was perpendicularly irradiated with laser light 260 from above. Thus, a strengthened portion having planar compressive stress formed therein was formed in the end surface 212.

As a light source for the laser light 260 was used a fiber laser having a wavelength (1,070 nm) which mainly caused linear absorption. The position irradiated with the laser light 260 lay in a sheet-thickness-direction center portion of the end surface 212 of the glass sheet 200, and the position being irradiated was moved in the longitudinal direction of the glass sheet 200 at a moving speed of 10.0 mm/sec. The area in the end surface 212 of the strengthened glass sheet 200 which was irradiated with the laser light 260 had a shape having a width of 2 mm and a length of 100 mm. The position where irradiation with the laser light 260 was initiated was such that the center of the shape of the area in the end surface 12 of the glass sheet 10 which was being irradiated with the laser light 60 lay inside the edge of the glass sheet 10, on the end surface 12 of the glass sheet 10.

The width-direction depth f of the light condensing point (see FIG. 5) from the end surface 212 of the strengthened glass sheet 200 was 30 mm, and the power P (not shown) of the light source for the laser light 260 was 1,550 W. The glass sheet had an absorption coefficient of 0.57 [1/cm].

As a result of the irradiation with the laser light 260, a portion lying in position D at a distance from the end surface 212 of the strengthened glass sheet 200 along a direction normal to the end surface 212, the distance being equal to the thickness of the strengthened glass sheet 200, has a temperature not lower than the strain point of the strengthened glass sheet 200. The end surface 212 of the strengthened glass sheet 200 had a temperature of 532° C. Since the glass sheet 10 had a softening point of 730° C., the temperature of the end surface 212 was lower than the softening point and T1>T2 held.

The strengthened portion of the strengthened glass sheet 200 of Example 5 had a maximum value of planar compressive stress of 2.8 MPa and had a thickness C, as measured from the end surface 212, of 8 mm. The thickness C was 2.85 times the thickness T (2.8 mm) of the glass sheet 200. The strengthened portion had no planar tensile stress therein. The planar compressive stress of the strengthened portion was determined with a two-dimensional birefringence distribution analyzer (WPA-100, manufactured by Photonic Lattice, Inc.).

After the irradiation with the laser light 260, a transparent adhesive tape (J6150, manufactured by Nitoms, Inc.) was applied as a protective layer to each end surface 212 which had been irradiated with the laser light 260. Thereafter, each glass sheet 200 was subjected to a four-point bending test in which the glass sheet was held, with the end surface 212 faced downward, and was bent so as to protrude downward. The upper span and the lower span were 300 mm and 900 mm, respectively, and the head speed was 1 mm/min. As a result, the average fracture stress was found to be 458 MPa. Moreover, the 0.1% fracture probability strength, determined on the assumption that the logarithm of the fracture stresses gave a normal distribution, was 329 MPa, and the Weilbull coefficient was 20.65.

### Example 6

Sixteen strengthened glass sheets were prepared in the same manner as in Example 5, but the end surfaces 212 were not irradiated with the laser light 260. The strengthened glass sheets were subjected to the four-point bending test in the same manner as in Example 5. As a result, the average fracture stress was found to be 324 MPa. Furthermore, the 0.1% fracture probability strength, determined on the assumption that the logarithm of the fracture stresses gave a normal distribution, was 46.9 MPa and the Weilbull coefficient was 2.63.

A comparison between the results of the four-point bending test in Example 5 and those in Example 6 shows that the average fracture stress and Weilbull coefficient regarding bending strength of Example 5, in which end surface irradiation with laser light had been conducted, were higher than the average fracture stress and Weilbull coefficient regarding bending strength of Example 6, in which end surface irradiation with laser light had not been conducted. Furthermore, the 0.1% fracture probability strength, determined on the assumption that the logarithm of the fracture stresses gave a normal distribution, of Example 5, in which end surface irradiation with laser light had been conducted, was higher than the 0.1% fracture probability strength, determined on the assumption that the logarithm of the bending strengths gave a normal distribution, of Example 6, in which end surface irradiation with laser light had not been conducted. It was thus demonstrated that the irradiation of an end surface with laser light forms a strengthened portion therein and the end surface can be thereby strengthened.

The results given above show that an end surface of a glass sheet can be strengthened by irradiating the end surface with laser light to form a strengthened portion along the end surface. Although why the formation of a strengthened portion in an end surface improves the fracture stress has not been elucidated in detail, it is thought that the irradiation with laser light not only brought about an improvement in strength due to the stress but also healed any flaws which the end surface of the glass sheet had received, resulting in enhanced strength.

TABLE 1

| | | Examples 1 to 6 |
|---|---|---|
| Glass composition | SiO₂ | 70.5 |
| (mol %) | Al₂O₃ | 0.8 |
| | MgO | 7.0 |
| | CaO | 9.0 |
| | Na₂O | 12.6 |
| | K₂O | 0.1 |
| | Fe₂O₃ | 0.04 |

| | |
|---|---|
| Tg (° C.) | 553 |
| Specific gravity | 2.504 |
| Young's modulus (GPa) | 71.9 |
| Average coefficient of thermal expansion (×10⁻⁷/° C.) | 85 |

TABLE 2

| | Ex. 1 | Ex. 2 | Ex. 3 | Ex. 4 | Ex. 5 | Ex. 6 |
|---|---|---|---|---|---|---|
| Shorter-side length a of glass sheet (mm) | 15 | 15 | 15 | 15 | 100 | 100 |
| Longer-side length b of glass sheet (mm) | 70 | 70 | 70 | 70 | 1000 | 1000 |
| Thickness T of glass sheet (mm) | 2.8 | 2.8 | 1.8 | 1.8 | 2.8 | 2.8 |
| CS (MPa) | 561 | 561 | 664 | 664 | 465 | 465 |
| DOL (μm) | 10.0 | 10.0 | 9.4 | 9.4 | 15.9 | 15.9 |
| Maximum value of planar compressive | 22.1 | 1.9 | 62.7 | 2.1 | 2.8 | 1.3 |
| stress of strengthened portion (MPa) | | | | | | |
| Width C of strengthened portion from end | 2.7 | 0.77 | 3.0 | 0.52 | 8.0 | 1.1 |
| surface (mm) | | | | | | |
| Average fracture stress (MPa) | 346 | 311 | 208 | 84 | 458 | 324 |
| Logarithmic 0.1% fracture probability | 259 | 122 | 159 | 66 | 329 | 46.9 |
| (MPa) | | | | | | |
| Weilbull coefficient | 12.3 | 3.6 | — | — | 20.65 | 2.63 |

While the present invention has been described in detail and with reference to specific embodiments thereof, it will be apparent to one skilled in the art that various changes and modifications can be made therein without departing from the spirit and scope thereof. This application is based on a Japanese patent application filed on Jun. 27, 2019 (Application No. 2019-120489), the contents thereof being incorporated herein by reference.

### INDUSTRIAL APPLICABILITY

The strengthened glass sheet of the present invention is suitable for use as, for example, windows of buildings, external walls, handrail materials, cover glasses for solar cells, or windows of vehicles.

### REFERENCE SIGNS LIST

10 Strengthened glass sheet
11a First main surface
11b Second main surface
12 End surface
30 Strengthened portion

1. A strengthened glass sheet having a first main surface, a second main surface which faces the first main surface, and an end surface,
wherein at least one of the first main surface and the second main surface has a surface compressive stress formed by a chemical strengthening treatment,
the strengthened glass sheet comprises a strengthened portion in which a planar compressive stress is formed along the end surface in a direction parallel with the end surface,
the planar compressive stress of the strengthened portion has a maximum value of 1-120 MPa, and
the strengthened portion has a width, as measured from the end surface in a direction normal to the end surface, of 0.5 times or more a thickness of the strengthened glass sheet.

2. The strengthened glass sheet according to claim 1, wherein the surface compressive stress has a CS of 200 MPa or more.

3. The strengthened glass sheet according to claim 1, wherein the surface compressive stress has a DOL of 5 μm or more.

4. The strengthened glass sheet according to claim 1, wherein the end surface comprising the strengthened portion has no surface compressive stress formed therein by a chemical strengthening treatment.

5. The strengthened glass sheet according to claim 1, wherein the strengthened portion has no planar tensile stress.

6. The strengthened glass sheet according to claim 1, comprising a protective layer provided to the end surface comprising the strengthened portion.

7. The strengthened glass sheet according to claim 1, comprising, in mole percentage on an oxide basis, 0.003-1.5% Fe₂O₃, 56-75% SiO₂, 0-20% Al₂O₃, 8-22% Na₂O, 0-10% K₂O, 0-14% MgO, 0-5% ZrO₂, and 0-12% CaO.

8. The strengthened glass sheet according to claim 1, wherein the strengthened portion has been formed to the end surface in a position located at a distance of 1.0 to 10 times the thickness of the strengthened glass sheet from a corner where the end surface meets an adjoining end surface.

9. The strengthened glass sheet according to claim 1, having a planar tensile stress formed in a direction parallel with the end surface in a position adjacent to the strengthened portion on the opposite side to the end surface.

10. The strengthened glass sheet according to claim 1, having an even specific gravity as a whole.

11. The strengthened glass sheet according to claim 1, wherein the end surface has a chamfer at a boundary between the end surface and the first main surface and at a boundary between the end surface and the second main surface.

12. A method of producing the strengthened glass sheet according to claim 1, the method comprising:
a chemical strengthening treatment step of immersing at least one of main surfaces of a glass sheet in a molten salt to form a surface compressive stress in the main surface of the glass sheet; and
an end surface strengthening step of, after the chemical strengthening treatment step, forming a planar compressive stress along an end surface of the glass sheet in a direction parallel with the end surface,
wherein in the end surface strengthening step, the glass sheet is heated so that a temperature T1 is not lower than a strain point of the glass sheet, where the temperature T1 is a temperature of a portion of the glass sheet lying at a distance equal to a thickness of the strengthened glass sheet from the end surface along a direction normal to the end surface; the end surface has a temperature T2 which is lower than a softening point of the glass sheet; and a relation T1>T2 is satisfied.

13. The method of producing a strengthened glass sheet according to claim 12, wherein in the end surface strengthening step, the planar compressive stress is formed in the end surface of the glass sheet by irradiation with laser light.

14. The method of producing a strengthened glass sheet according to claim 13, wherein in the end surface strengthening step, the laser light with which the glass sheet is irradiated has such a wavelength that the glass sheet has an absorption coefficient α less than 100 [cm⁻¹].

15. The method of producing a strengthened glass sheet according to claim 13, wherein in the end surface strengthening step, the wavelength of the laser light is 250-5,000 nm.

16. The method of producing a strengthened glass sheet according to claim 12, comprising, after the chemical strengthening treatment step, a cutting step of cutting the glass sheet that has undergone the chemical strengthening treatment.

17. The method of producing a strengthened glass sheet according to claim 16, wherein in the cutting step, the glass sheet is cut by a method in which thermal-stress scribing is used.

18. The method of producing a strengthened glass sheet according to claim 12, wherein a protective layer is formed on the end surface after the end surface strengthening step.
